(19) United States
(12) Patent Application Publication
(10) Pub. No.: US 2019/0048804 A1
(43) Pub. Date: Feb. 14, 2019

(54) HEAT ENGINE AND METHOD FOR OPERATING A HEAT ENGINE

(71) Applicant: Dürr Systems AG, Bietigheim-Bissingen (DE)

(72) Inventors: Roland Stoll, Bietigheim-Bissingen (DE); Axel Widenhorn, Stuttgart (DE)

(73) Assignee: Dürr Systems AG, Bietigheim-Bissingen (DE)

(21) Appl. No.: 16/076,956

(22) PCT Filed: Feb. 7, 2017
(86) PCT No.: PCT/EP2017/052665

§ 371 Date: Aug. 9, 2018

(30) Foreign Application Priority Data
Feb. 10, 2016 (DE) 10 2016 201 974.0

(51) Int. Cl. F02C 9/18; F02C 7/08; F02C 3/04

(52) U.S. Cl. CPC F02C 9/18; F02C 7/08; F05D 2270/303; F05D 2260/606; F05D 2270/053; F02C 3/04

(57) ABSTRACT

Heat engine and method for operating a heat engine are disclosed. A disclosed method for operating a heat engine-includes supplying gas containing combustible constituents as supply air to a combustion chamber of a combustion apparatus-of the heat engine; supplying fuel to the combustion chamber; removing exhaust gas from the combustion chamber and supplying the exhaust gas to a heat exchanger of the heat engine; transferring heat from the exhaust gas to at least a part of the supply air by the heat exchanger; guiding a part of at least one of the supply air or a part of the exhaust gas past the heat exchanger by a bypass guide, wherein at least one of a mass stream or volumetric stream of at least one of the part of the supply air or the exhaust gas guided past the heat exchanger-is at least one of controlled or regulated-so that at least one of a thermal power or a mechanical power of the heat engine is approximately constant over time.

### RELATED APPLICATION

This application is a national phase of international application No. PCT/EP2017/052665 filed on Feb. 7, 2017, and claims the benefit of German application No. 10 2016 201 974.0 filed on Feb. 10, 2016, which are incorporated herein by reference in their entirety and for all purposes.

### FIELD OF DISCLOSURE

The present invention relates to a method for operating a heat engine, which comprises, for example, a gas turbine, in particular a micro gas turbine.

### BACKGROUND

Heat engines and methods for the operation thereof are known from DE 10 2013 203 448 A1 and from DE 10 2013 005 764 A1, for example.

### SUMMARY OF THE INVENTION

The object underlying the present invention is to provide a method for operating a heat engine, which enables a reliable operation of the heat engine, in particular in the case of variable boundary conditions.

This object is achieved in accordance with the invention by a method for operating a heat engine, wherein the method comprises the following: supplying gas containing combustible constituents as supply air to a combustion chamber of a combustion apparatus of the heat engine; supplying fuel to the combustion chamber:

removing exhaust gas from the combustion chamber and supplying the exhaust gas to a heat exchanger of the heat engine;

transferring heat from the exhaust gas to at least a part of the supply air by means of the heat exchanger;

guiding a part of the supply air and/or a part of the exhaust gas past the heat exchanger by means of a bypass guide, wherein a mass stream and/or volumetric stream of the part of the supply air and/or the exhaust gas guided past the heat exchanger is controlled and/or regulated in such a way that a thermal power and/or a mechanical power of the heat engine are at least approximately constant over time.

By controlling and/or regulating the mass stream and/or volume stream of the part of the supply air and/or the exhaust gas guided past the heat exchanger in accordance with the invention, it is preferably possible to flexibly react to varying boundary conditions, in particular in order to keep the thermal power and/or the mechanical power of the heat engine at least approximately constant over time.

The invention may in particular offer the advantage that fluctuations in the composition of the gas containing combustible constituents, in particular different concentrations of the combustible constituents, are able to be compensated and/or balanced. As a result, a constant operation of the heat engine is preferably made possible. In particular, it may preferably hereby be prevented that a heat engine configured as a gas turbine, for example a heat engine configured as a micro gas turbine, is operated with increased, in particular excessive, rotational speed (engine speed) due to temporarily increased concentrations of the combustible constituents of the supplied gas, which could ultimately lead to damages to the heat engine.

The heat engine may thus be used for exhaust air purification, for example, and thereby be supplied with an exhaust air gas stream having fluctuating concentration of the combustible constituents as supply air to the combustion chamber, without this resulting in an undesired fluctuation or at least undesirably large fluctuation in the operating parameters of the heat engine.

It may be favorable if a mass stream and/or volumetric stream of the fuel supplied to the combustion chamber is constant over time, in particular independently of a change in the mass stream and/or volumetric stream of the part of the exhaust gas and/or the supply air guided past the heat exchanger.

Further, the mass stream and/or the volumetric stream of the fuel supplied to the combustion chamber is preferably kept constant over time, independently of a change over time in the concentration of the combustible constituents of the gas supplied as supply air.

A mass stream and/or volumetric stream of the supply air supplied to the combustion chamber is preferably constant over time. In particular, the mass stream and/or volumetric stream of the supply air supplied to the combustion chamber is preferably kept constant, independently of whether a change in concentration of the combustible constituents of the gas supplied as supply air occurs during the operation of the heat engine.

In an embodiment of the invention, provision may be made for a fluctuation in a concentration of the combustible constituents of the gas and the fluctuating heating power in the combustion chamber resulting therefrom to be compensated by controlling and/or regulating the heat transfer from the exhaust gas to the supply air.

For controlling and/or regulating the heat transfer from the exhaust gas to the supply air, in particular the mass stream and/or volumetric stream of the part of the supply air and/or the exhaust gas guided past the heat exchanger is varied.

It may be favorable if, by means of one or more sensor apparatuses, one or multiple or all of the following parameters are determined and used for controlling and/or regulating the bypass guide:

a combustion chamber entry temperature;

a combustion chamber exit temperature;

a turbine entry temperature;

a turbine exit temperature;

a supply air temperature upstream of the heat exchanger;

a supply air temperature downstream of the heat exchanger.

Alternatively or in addition hereto, provision may be made for one or multiple or all of the following parameters to be determined by means of one or more sensor apparatuses and used for controlling and/or regulating the bypass guide:

a concentration of the combustible constituents in the gas supplied as supply air;

a chemical composition of the gas supplied as supply air.

It may be advantageous if one operating parameter or multiple operating parameters of an installation, which produces the gas containing the combustible constituents, are used for controlling and/or regulating the bypass guide. In particular, in the case of known correlation between the operating parameters of the installation on the one hand and the gas composition of the gas supplied as supply air on the other, a direct influencing of the controlling and/or regulation of the bypass guide may be provided, for example by way of the selection of predefined bypass operating modes.

In an embodiment of the invention, it may be provided that, in the case of an operating mode of the installation producing the gas, a concentration of the combustible constituents of the gas is known and a corresponding controlling and/or regulation of the bypass guide is performed, in particular in order to operate the heat engine at an optimal operating point. In the case of a variation of the operating mode of the installation, which produces the gas containing the combustible constituents, a correspondingly altered controlling and/or regulation of the bypass guide of the heat engine may preferably occur by utilizing a known concentration of the combustible constituents in the produced gas in this operating mode, in particular in order to keep the thermal power and/or mechanical power of the heat engine at least approximately constant over time, independently of the stated operating modes of the installation.

In an embodiment of the invention, provision may be made for it to be determined by means of a sensor apparatus whether the heat transfer from the exhaust gas to the supply air already leads to the exothermic reaction of the combustible constituents of the gas. The bypass guide is then preferably controlled and/or regulated in such a way that the temperature of the gas guided to the combustion chamber as supply air and/or the temperature within the heat exchanger is always below a specified threshold value. For example, the temperature within the heat exchanger may be reduced by appropriately controlling and/or regulating the bypass guide, in order to avoid exothermic reactions of the combustible constituents of the gas in the heat exchanger.

The gas containing combustible constituents is preferably process exhaust gas, which in particular is purified by means of the heat engine.

“Purify” is hereby to be understood in particular as a chemical conversion, in particular rendering harmless, of volatile organic compounds and other contaminants or pollutants.

Alternatively or in addition hereto, provision may be made for an exhaust gas from the combustion chamber to be passed through a catalytic device or supplied to a catalytic device, which in particular is provided and configured to oxidize an amount of low volatile hydrocarbons (volatile organic compounds, VOC) remaining in the exhaust gas and/or to reduce an amount of nitrogen oxides (NOₓ).

The method in accordance with the invention is suited in particular for performing on a heat engine or by means of a heat engine.

The present invention therefore also relates to a heat engine.

In this regard, the object underlying the invention is to provide a heat engine, which is constructed in a simple manner and enables a reliable operation even in the case of fluctuating boundary conditions.

This object is achieved in accordance with the invention by a heat engine, which comprises the following:

a combustion apparatus, which comprises a combustion chamber;

a supply air feed for supplying supply air to the combustion chamber;

a fuel feed for supplying fuel to the combustion chamber;

an exhaust gas discharge for removing exhaust gas from the combustion chamber;

a heat exchanger, by means of which the exhaust gas discharge and the supply air feed are thermally coupled to each other;

a bypass guide, by means of which at least a part of the supply air and/or the exhaust gas is guidable past the heat exchanger, in particular while avoiding a heat transfer from the exhaust gas to the supply air;

a control apparatus, by means of which a mass stream and/or volumetric stream of the part of the supply air and/or the exhaust gas guided past the heat exchanger by means of the bypass guide is controllable and/or

regulatable in such a way that a thermal power and/or a mechanical power of the heat engine are at least approximately constant.

The heat engine in accordance with the invention preferably has individual or a plurality of the features and/or advantages described in conjunction with the method in accordance with the invention.

Further, the method in accordance with the invention preferably has individual or a plurality of the features and/or advantages described in conjunction with the heat engine in accordance with the invention.

It may be favorable if the heat engine comprises a gas turbine, in particular a micro gas turbine.

The heat engine and/or the control apparatus are preferably configured and set up such that the method in accordance with the invention is performable by means of the heat engine.

It may be favorable if the heat engine comprises one or more sensor apparatuses for determining individual or multiple or all of the following parameters:

a combustion chamber entry temperature;

a combustion chamber exit temperature;

a turbine entry temperature;

a turbine exit temperature;

a supply air temperature downstream of the heat exchanger;

a supply air temperature upstream of the heat exchanger;

a concentration of the combustible constituents in the gas supplied as supply air;

and/or

a chemical composition of the gas supplied as supply air.

It may be favorable if the heat engine comprises a signal coupling apparatus for coupling the heat engine to transmit information to an installation, which produces the gas containing the combustible constituents. By means of the signal coupling apparatus, one operating parameter or multiple operating parameters of the installation, which produces the gas containing the combustible constituents, are preferably transmittable to the heat engine, in particular the control apparatus of the heat engine, for controlling and/or regulating the bypass guide.

The heat engine is suited in particular for use in a thermal power system, which comprises a heat engine in accordance with the present invention and an installation, which produces the gas containing the combustible constituents.

Such an installation may, for example, be a painting installation, a drier installation, or another treatment installation for the treatment of workpieces.

The heat engine in accordance with the invention is suited in particular for performing the method in accordance with the invention.

The present invention therefore also relates to the use of a heat engine in accordance with the invention for performing the method in accordance with the invention.

The use in accordance with the invention preferably has individual or a plurality of the features and/or advantages described in conjunction with the method in accordance with the invention and/or the heat engine in accordance with the invention.

Further, the method in accordance with the invention, the heat engine in accordance with the invention, and/or the use in accordance with the invention may have individual or a plurality of the subsequently described features and/or advantages:

It may be favorable if the heat exchanger is a recuperator.

The heat engine preferably comprises a gas turbine, in particular a micro gas turbine, which serves as a combustion apparatus of the heat engine.

The gas containing combustible constituents, which is supplied to the combustion chamber as supply air, is preferably exhaust gas from industry processes or gasification processes. For example, the gas is a lean gas from a gasification process.

The gas contains in particular low volatility hydrocarbons (volatile organic compounds VOC).

By controlling and/or regulating the bypass guide in accordance with the invention, an excessive temperature in the combustion space, which may lead to a damaging of the combustion space and of the subsequent turbine, may preferably be avoided.

In accordance with the invention, in particular a stable and constant operation of the heat engine is achieved independently of a temporally varying heating value of the gas stream supplied as supply air.

It may be favorable if the heat engine comprises a catalytic device. In particular, an exhaust gas purification may be performed in the exhaust gas discharge by means of such a catalytic device. An amount of low volatility hydrocarbons (volatile organic compounds, VOC) may preferably be oxidized and/or an amount of nitrogen oxides (NOₓ) reduced by means of the catalytic device.

It may be favorable if the catalytic device is arranged and/or formed before (upstream) and/or in and/or after (downstream) the heat exchanger, with respect to a flow direction of the exhaust gas.

It may be advantageous if an exhaust gas is removed from the combustion chamber and is purified by means of a catalytic device. The exhaust gas is preferably catalytically purified downstream of a turbine and/or upstream of the heat exchanger and/or downstream of the heat exchanger and/or within the heat exchanger, with respect to a flow direction of the exhaust gas. The exhaust gas is preferably purified in such a way that an amount of low volatility hydrocarbons (volatile organic compounds, VOC) is oxidized and/or an amount of nitrogen oxides (NOₓ) reduced.

Further preferred features or advantages of the invention are subject matter of the subsequent description and the illustrative depiction of an exemplary embodiment.

### BRIEF DESCRIPTION OF THE DRAWING

FIG. 1 shows a schematic depiction of an embodiment of a heat engine, in which a controlling and/or regulation of the heat transfer from the exhaust gas to the supply air is provided.

### DETAILED DESCRIPTION OF THE DRAWING

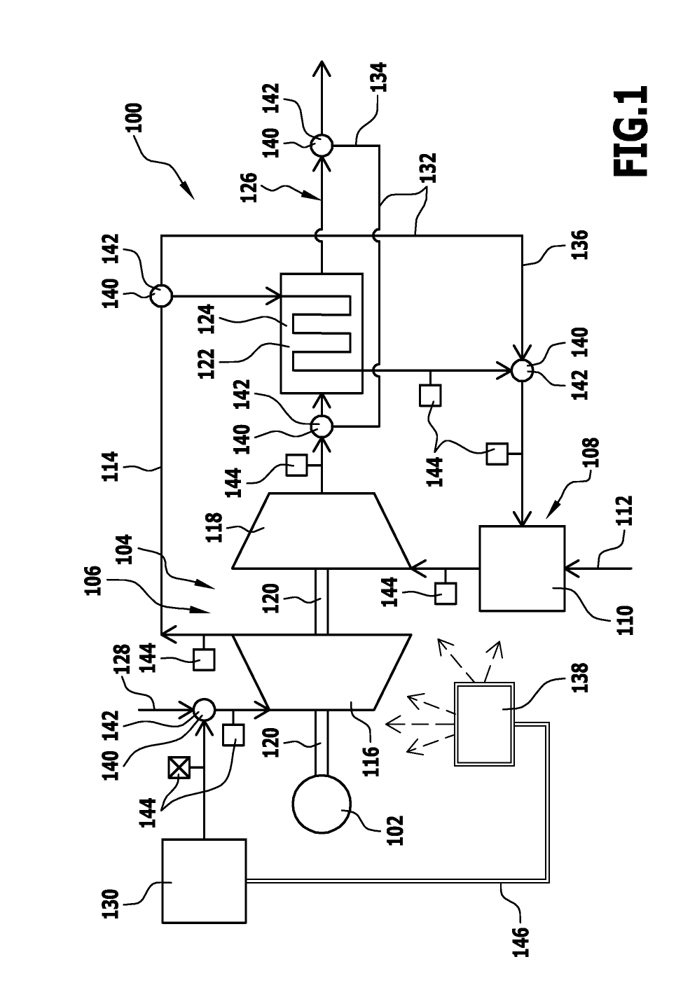

An embodiment depicted in FIG. 1 of a heat engine designated as a whole with 100 serves in particular to convert heat produced by means of fuel into mechanical energy. This mechanical energy may, for example, be converted into electrical energy by means of a generator 102 of the heat engine 100.

The heat engine machine 100 comprises in particular a gas turbine 104, for example a micro gas turbine 106.

A combustion apparatus 108 of the heat engine 100 preferably comprises a combustion chamber 110, to which fuel is suppliable by means of a fuel feed 112 and to which supply air, in particular oxidizer, is suppliable by means of a supply air feed 114.

The heat engine 100, in particular the gas turbine 104, preferably comprises a compression apparatus 116 for compressing supply air and a turbine 118 for expanding exhaust gas produced in the combustion chamber 110.

The compression apparatus 116, the turbine 118, and preferably also the generator 102 are preferably arranged on a common shaft 120, such that the mechanical energy obtained from the expansion of the exhaust gas by means of the turbine 118 may be simply transferred and used for compressing the supply air by means of the compression apparatus 116 as well as for generating electrical energy by means of the generator 102.

The gas turbine 104 further comprises a heat exchanger 122 for transferring heat contained in the exhaust gas from the combustion chamber 110 to the supply air.

The heat exchanger 122 is thus in particular a recuperator 124.

In particular, the supply air feed 114 is thermally coupled to an exhaust gas discharge 126 of the heat engine 100 by means of the heat exchanger 122.

The exhaust gas discharge 126 serves in particular to remove exhaust gas produced in the combustion chamber 110.

Fresh air, for example, may be used as supply air.

The supply air feed 114 may thus comprise a fresh air feed 128, for example.

The heat engine 100 preferably serves to purify a gas stream, which in particular contains combustible constituents.

For this purpose, the heat engine 100 may, for example, be linked or otherwise connected to an installation 130, which produces gas containing combustible constituents.

The gas produced in the installation 130, for example process exhaust gas or lean gas from gasification processes, is in particular suppliable as supply air to the combustion chamber 110 via the supply air feed 114.

Due to the high temperatures present in the combustion chamber 110, combustible constituents as well as pollutants and other contaminants contained in the supply air are preferably chemically converted and thereby rendered harmless.

The heat engine 100 thus preferably serves to purify a gas stream of any installation 130.

The heat engine 100 is preferably to be operated with operating parameters that are as constant as possible, in particular in order to ensure an efficient energy conversion and simultaneously to avoid an undesired damaging of components of the heat engine 100.

In particular in the case of fluctuating gas composition of the gas produced by the installation 130 and used as supply air, a different heating value of the supply air may arise, which may ultimately lead to varying temperatures in the combustion chamber 110 and thus different rotational speeds of the turbine 118.

In order to here be able to ensure an operation of the heat engine 100 that is as constant as possible and thus more constant temperatures in the combustion chamber 100 and constant rotational speeds of the turbine 118, the heat engine 100 preferably enables a compensation of the fluctuating gas composition of the gas supplied as supply air.

For example, the heat engine 100 serves for exhaust air purification, in which exhaust air containing combustible constituents is supplied as supply air to the combustion chamber 110 of the heat engine 100. By specifically controlling and/or regulating the heat engine 100, fluctuations in the concentration of the combustible constituents in the exhaust air may preferably be compensated. An overspeeding of the heat engine 100, from which a damaging or even destruction of the heat engine 100 may result, is thus ruled out.

For this purpose, the heat engine 100 comprises in particular a bypass guide 132, by means of which supply air and/or exhaust gas is guidable past the heat exchanger 122.

The bypass guide 132 thereby preferably comprises an exhaust gas bypass 134, by means of which at least a part of the exhaust gas is guidable past the heat exchanger 122, and/or a supply air bypass 136, by means of which at least a part of the supply air is guidable past the heat exchanger 122.

The heat engine 100 preferably further comprises a control apparatus 138 for controlling and/or regulating the mass stream and/or volumetric stream of the part of the supply air guided past the heat exchanger, and/or the mass stream and/or volumetric stream of the part of the exhaust gas guided past the heat exchanger 122.

In particular, the heat engine 100 comprises one or more control elements 140, for example valves 142 or flaps, by means of which it is variable which mass stream and/or volumetric stream of the supply air and/or the exhaust gas is guided through the heat exchanger 122 or therepast.

The control elements 140, in particular the valves 142 or flaps, are thereby in particular flow path branchings or flow path junctions or flow path redirections or flow path blockades for branching, joining, redirecting, or blocking (partial) supply air streams and/or (partial) exhaust gas streams.

By appropriately controlling the control elements 140, in particular the heat transfer from the exhaust gas to the supply air may be influenced, in order to obtain different combustion chamber entry temperatures.

The combustion chamber entry temperatures are thereby selected in particular such that a varying heating value of the supplied supply air is compensated, in order to ultimately obtain a constant combustion chamber exit temperature.

The control and/or regulation by means of the control apparatus 138 may thereby in particular be performed depending on measurement values of one or more sensor apparatuses 144.

In particular, the combustion chamber entry temperature, the combustion chamber exit temperature, a turbine entry temperature, a turbine exit temperature, a supply air temperature downstream of the heat exchanger 122 and/or a supply air temperature upstream of the heat exchanger 122 may hereby be determined by means of the one or more sensor apparatuses 144 and/or used for controlling and/or regulating the control elements 140 of the control apparatus 138.

Further, by means of one or more sensor apparatuses 144, a concentration of the combustible constituents in the gas supplied as supply air and/or a chemical composition of the gas supplied as supply air may be determined and/or used for controlling and/or regulating the control elements 140 of the control apparatus 138.

Alternatively or in addition hereto, provision may be made for the heat engine 100 to comprise a signal coupling apparatus 146, by means of which the heat engine 100 is coupleable or coupled signal-wise to the installation 130 for producing the gas containing combustible constituents.

The heat engine 100, in particular the control apparatus 138, may then in particular be controlled and/or regulated depending on various operating states of the installation 130, in particular in order to adapt the supply air temperature to already known or expected heating values of the gas produced by means of the installation 130.

The heat engine 100 described above preferably functions as follows:

For operating the heat engine 100, fuel is supplied to the combustion chamber 110 by means of the fuel feed 112 and supply air, in particular oxidizer, is supplied to the combustion chamber 110 by means of the supply air feed 114.

In particular, fresh air is thereby supplied to the combustion chamber 110 by way of the fresh air feed 128 and/or gas from a gas-producing installation 130 is supplied to the combustion chamber 110 by way of the supply air feed 114.

The supplied substances are chemically converted in the combustion chamber 110. In particular, an exothermic reaction hereby occurs, such that heat is released.

This thermal energy thus produced is partially converted into mechanical energy by way of expansion by the turbine 118 and is transferred via the shaft 120 to the compression apparatus 116 for compressing the supply air on the one hand and to the generator 102 for generating electrical energy on the other hand.

To optimize the efficiency of the heat engine 100, the exhaust gas from the combustion chamber 110 removed by the turbine 118 is not immediately removed, but rather is used further. In particular, heat is removed from the exhaust gas and used for heating the supply air.

For this purpose, the exhaust gas on the one hand and the supply air on the other hand are brought into thermal contact in the heat exchanger 122, such that heat may be transferred, in particular indirectly, from the exhaust gas to the supply air.

By means of the control apparatus 138, in particular the control elements 140, it is thereby controlled and/or regulated which part of the total supplied supply air and/or which part of the total removed exhaust gas is guided through the heat exchanger 122 or therepast via the bypass guide 132. As a result, it may in particular ultimately be varied which temperature the supplied supply air has at the combustion chamber entry.

The gas supplied from the installation 130 of the heat engine 100 preferably contains combustible constituents. Depending on the operating mode of the installation 130, different concentrations of the combustible constituents may hereby arise.

In particular, a heating value of the supply air supplied to the combustion chamber 110 via the supply air feed 144 thus varies.

Due to this variation in the heating value, in the case of otherwise constant operating parameters of the heat engine 100, in particular in the case of constant mass stream and/or volumetric stream of the supply air and/or in the case of constant mass stream and/or volumetric stream of the fuel, a fluctuating combustion chamber exit temperature arises, which ultimately may result in a strong thermal and mechanical stress on the combustion chamber 110 and/or the turbine 118. In the worst case, the heat engine 100 may even be damaged as a result.

For an operation of the heat engine 100 that is as uniform and damage-free as possible, influence on the control elements 140 and thus influence on the bypass guide 132 is exerted by means of the control apparatus 138.

In particular, depending on values determined by means of the one or more sensor apparatuses 144, for example the temperatures present and/or the gas composition of the supply air, the part of the exhaust gas guided through the heat exchanger 122 and/or the part of the supply air guided through the heat exchanger 122 is varied with respect to the mass stream and/or volumetric stream.

In the case of high heating value of the supply air, which may result in an increased combustion chamber exit temperature, a larger bypass stream in the supply air bypass 136 and/or in the exhaust gas bypass 134 is then preferably selected in order to reduce the combustion chamber entry temperature.

In the case of low heating value, which may result in a lower combustion chamber exit temperature, the heat transfer from the exhaust gas to the supply air is increased by way of enlargements of the mass stream and/or volumetric stream of the supply air and/or the exhaust air flowing through the heat exchanger 122, in particular in order to ultimately generate an increased combustion chamber entry temperature.

In all cases, a variation or fluctuation in the heating value of the supply air is thus preferably compensated in order to ultimately preferably obtain a constant thermal power and/or mechanical power of the heat engine 100.

1. Method for operating a heat engine, the method comprising:
supplying gas containing combustible constituents as supply air to a combustion chamber of a combustion apparatus of the heat engine;
supplying fuel to the combustion chamber;
removing exhaust gas from the combustion chamber and supplying the exhaust gas to a heat exchanger of the heat engine;
transferring heat from the exhaust gas to at least a part of the supply air by the heat exchanger; and
guiding a part of at least one of the supply air or a part of the exhaust gas past the heat exchanger by a bypass guide, wherein at least one of a mass stream or volumetric stream of at least one of the part of the supply air or the exhaust gas guided past the heat exchanger is controlled so that at least one of a thermal power or a mechanical power of the heat engine is approximately constant over time.

2. Method in accordance with claim 1, wherein at least one of a mass stream or volumetric stream of the fuel supplied to the combustion chamber is approximately constant over time.

3. Method in accordance with claim 1, wherein at least one of a mass stream or volumetric stream of the supply air supplied to the combustion chamber is approximately constant over time.

4. Method in accordance with claim 1, wherein a fluctuation in a concentration of the combustible constituents of the gas and the fluctuating heating power in the combustion chamber resulting therefrom is compensated by controlling the heat transfer from the exhaust gas to the supply air.

5. Method in accordance with claim 1, wherein one or multiple or all of the following parameters are determined by one or more sensor apparatuses and used for controlling the bypass guide:
a combustion chamber entry temperature;
a combustion chamber exit temperature;
a turbine entry temperature;
a turbine exit temperature; or
a supply air temperature at least one of upstream or downstream of the heat exchanger.

6. Method in accordance with claim 1, wherein one or all of the following parameters are determined by one or more sensor apparatuses and used for controlling the bypass guide:
a concentration of the combustible constituents in the gas supplied as supply air; or
a chemical composition of the gas supplied as supply air.

7. Method in accordance with claim 1, wherein an operating parameter or multiple operating parameters of an installation, which produces the gas containing the combustible constituents, is used for controlling the bypass guide.

8. Method in accordance with claim 1, wherein it is determined by a sensor apparatus whether the heat transfer from the exhaust gas to the supply air leads to the exothermic reaction of the combustible constituents of the gas, and wherein the bypass guide is controlled in such a way that at least one of the temperature of the gas supplied to the combustion chamber as supply air or the temperature within the heat exchanger is below a specified threshold value.

9. Method in accordance with claim 1, wherein the gas containing combustible constituents is process exhaust gas, which is purified by the heat engine.

10. Heat engine, comprising:
a combustion apparatus, which comprises a combustion chamber;
a supply air feed for supplying supply air to the combustion chamber;
a fuel feed for supplying fuel to the combustion chamber;
an exhaust gas discharge for removing exhaust gas from the combustion chamber;
a heat exchanger, by which the exhaust gas discharge and the supply air feed are thermally coupled to each other;
a bypass guide, by which at least one of a part of the supply air or the exhaust gas is guidable past the heat exchanger, while avoiding a heat transfer from the exhaust gas to the supply air; and
a control apparatus, by which at least one of a mass stream or a volumetric stream of at least one of the part of the supply air or the exhaust gas guided past the heat exchanger by the bypass guide is controllable in such a way that at least one of a thermal power or a mechanical power of the heat engine is approximately constant.

11. Heat engine in accordance with claim 10, wherein the heat engine comprises a gas turbine.

12. Heat engine in accordance with claim 10, wherein at least one of the heat engine or the control apparatus are configured such that a method as follows is performable by the heat engine, the method comprising:
supplying gas containing combustible constituents as supply air to a combustion chamber of a combustion apparatus of the heat engine;
supplying fuel to the combustion chamber;
removing exhaust gas from the combustion chamber and supplying the exhaust gas to a heat exchanger of the heat engine;
transferring heat from the exhaust gas to at least a part of the supply air by the heat exchanger; and
guiding a part of at least one of the supply air or a part of the exhaust gas past the heat exchanger by a bypass guide, wherein at least one of a mass stream or volumetric stream of at least one of the part of the supply air or the exhaust gas guided past the heat exchanger is controlled so that at least one of a thermal power or a mechanical power of the heat engine is approximately constant over time.

13. Heat engine in accordance with claim 10, wherein the heat engine comprises one or more sensor apparatuses for determining individual or multiple or all of the following parameters:
a combustion chamber entry temperature;
a combustion chamber exit temperature;
a turbine entry temperature;
a turbine exit temperature;
a supply air temperature at least one of upstream or downstream of the heat exchanger;
a concentration of the combustible constituents in the gas supplied as supply air; or
a chemical composition of the gas supplied as supply air.

14. Heat engine in accordance with claim 10, wherein the heat engine comprises a signal coupling apparatus for coupling the heat engine to transmit information to an installation, which produces the gas containing the combustible constituents, wherein one operating parameter or multiple operating parameters of the installation, which produces the gas containing the combustible constituents, is transmittable by the signal coupling apparatus to the heat engine for controlling the bypass guide.

15. Use of a heat engine comprising:
a combustion apparatus, which comprises a combustion chamber;
a supply air feed for supplying supply air to the combustion chamber;
a fuel feed for supplying fuel to the combustion chamber;
an exhaust gas discharge for removing exhaust gas from the combustion chamber;
a heat exchanger, by which the exhaust gas discharge and the supply air feed are thermally coupled to each other;
a bypass guide, by which at least one of a part of the supply air or the exhaust gas is guidable past the heat exchanger, while avoiding a heat transfer from the exhaust gas to the supply air; and
a control apparatus, by which at least one of a mass stream or a volumetric stream of at least one of the part of the supply air or the exhaust gas guided past the heat exchanger by the bypass guide is controllable in such a way that at least one of a thermal power or a mechanical power of the heat engine is approximately constant;
the heat engine for performing a method as follows, the method comprising:
supplying gas containing combustible constituents as supply air to a combustion chamber of a combustion apparatus of the heat engine;
supplying fuel to the combustion chamber;
removing exhaust gas from the combustion chamber and supplying the exhaust gas to a heat exchanger of the heat engine;
transferring heat from the exhaust gas to at least a part of the supply air by the heat exchanger; and
guiding a part of at least one of the supply air or a part of the exhaust gas past the heat exchanger by a bypass guide, wherein at least one of a mass stream or volumetric stream of at least one of the part of the supply air or the exhaust gas guided past the heat exchanger is controlled so that at least one of a thermal power or a mechanical power of the heat engine is approximately constant over time.

16. Heat engine in accordance with claim 11, wherein the gas turbine includes a micro gas turbine.
